(19) United States
(12) Patent Application Publication
(10) Pub. No.: US 2025/0054463 A1
(43) Pub. Date: Feb. 13, 2025

(54) DISPLAY CONTROL APPARATUS AND CONTROL METHOD

(71) Applicant: CANON KABUSHIKI KAISHA, Tokyo (JP)

(72) Inventor: YUSUKE CHIHARA, Chiba (JP)

(21) Appl. No.: 18/776,535

(22) Filed: Jul. 18, 2024

(30) Foreign Application Priority Data
Aug. 10, 2023 (JP) 2023-131468

(51) Int. Cl. G09G 5/10; H04N 9/69

(52) U.S. Cl. CPC G09G 5/10; H04N 9/69; G09G 2320/0247; G09G 2320/0666; G09G 2320/0673; G09G 2320/08; G09G 2340/0407; G09G 2370/12

(57) ABSTRACT

A display control apparatus comprises a selection unit that selects reproduction target content from a plurality of content, an output unit that outputs, to a display unit, the reproduction target content selected by the selection unit, and a control unit that controls setting information concerning a display characteristic set in the output unit and the display unit. The control unit controls not to change the setting information based on the reproduction target content in a case where the selection unit continuously changes the reproduction target content, and to change the setting information based on the reproduction target content in a case where the selection unit does not continuously change the reproduction target content.

### BACKGROUND OF THE INVENTION

### Field of the Invention

The present invention relates to a content display control.

### Description of the Related Art

An image capture apparatus such as a digital camera can generate High Dynamic Range (HDR) content with a dynamic range wider than that of conventional Standard Dynamic Range (SDR) content. To display HDR content generated by a digital camera while faithfully reproducing the content, a display apparatus capable of displaying HDR content is necessary.

When a display apparatus supporting the HDR is connected to a digital camera and reproduces HDR content generated by the digital camera, it is possible to display the HDR content while faithfully reproducing the color and brightness of the HDR content by making setting information (connection settings) concerning display characteristics such as the color gamut and gamma characteristic of content set in the digital camera and the display apparatus match with the display characteristics of the reproduction target content.

Japanese Patent Laid-Open No. 2014-229999 describes a technique of calculating the chroma of content and performing gamut conversion so as to match or become closer to the tone of the display apparatus. Japanese Patent Laid-Open No. 2009-064031 describes a technique of correcting original image data based on a virtual gamma curve according to the characteristics of a liquid crystal panel.

According to Japanese Patent Laid-Open No. 2014-229999, since the color gamut and gamma characteristic of content are converted in accordance with the dynamic range that can be displayed by the display apparatus, it may be impossible to faithfully express the color and brightness of the actual content. In addition, in a case where the display apparatus can faithfully display the color gamut and gamma characteristic of content but the connection settings of the display apparatus do not match the color gamut and gamma characteristic of reproduction target content, it is desirable to change the connection settings of the display apparatus to match the color gamut and gamma characteristic of the content. However, to change the connection settings, it is necessary to reconnect the digital camera and the display apparatus, and it may take about several seconds. In a case where, for example, the display apparatus reproduces content such as a still image or a moving image generated by the digital camera, if a reproduction target content is continuously changed among a plurality of content each of which has different color gamuts and gamma characteristics, the frequency of reconnection becomes high, thereby causing flickering of a screen. While the screen flickers, a user cannot visually perceive the reproduction target content, thereby degrading convenience.

### SUMMARY OF THE INVENTION

The present invention has been made in consideration of the aforementioned problems, and realizes techniques capable of suppressing flickering of a screen when reproducing a plurality of content each of which has different display characteristics while continuously changing the content.

In order to solve the aforementioned problems, the present invention provides a display control apparatus comprising: a selection unit that selects reproduction target content from a plurality of content; an output unit that outputs, to a display unit, the reproduction target content selected by the selection unit; and a control unit that controls setting information concerning a display characteristic set in the output unit and the display unit, wherein the control unit controls not to change the setting information based on the reproduction target content in a case where the selection unit continuously changes the reproduction target content, and to change the setting information based on the reproduction target content in a case where the selection unit does not continuously change the reproduction target content.

In order to solve the aforementioned problems, the present invention provides a method of controlling a display control apparatus which includes a selection unit that selects reproduction target content from a plurality of content, and an output unit that outputs, to a display unit, the reproduction target content selected by the selection unit, the method comprising: controlling setting information concerning a display characteristic set in the output unit and the display unit, wherein the controlling is performed so as not to change the setting information based on the reproduction target content in a case where the selection unit continuously changes the reproduction target content, and to change the setting information based on the reproduction target content in a case where the selection unit does not continuously change the reproduction target content.

According to the present invention, it is possible to suppress flickering of a screen when reproducing a plurality of content each of which has different display characteristics while continuously changing the content.

Further features of the present invention will become apparent from the following description of exemplary embodiments (with reference to the attached drawings).

### BRIEF DESCRIPTION OF THE DRAWINGS

FIGS. 1A and 1B are external views of a display control apparatus according to the present embodiment.

FIG. 2 is a block diagram illustrating an internal configuration of the display control apparatus according to the present embodiment.

FIG. 3 is a view illustrating transition of connection settings when continuously changing content according to the first embodiment.

FIGS. 4A and 4B are views illustrating a method of setting a standby time from when the continuous change of the content is stopped until the connection settings are changed according to the first embodiment.

FIGS. 5A and 5B are flowcharts illustrating display control processing according to the first embodiment.

FIG. 6 is a view illustrating transition of connection settings when continuously changing content according to the second embodiment.

FIGS. 7A and 7B are flowcharts illustrating display control processing according to the second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Hereinafter, embodiments in which a display control apparatus of the present invention is applied to an image capture apparatus such as a single-lens reflex digital camera capable of shooting a still image and recording a moving image will be described in detail with reference to the accompanying drawings.

The present embodiment will describe a case where a digital camera 100 and a display apparatus 300 are connected and the display apparatus 300 reproduces content such as a still image or a moving image generated by the digital camera 100.

### <Apparatus Configuration>

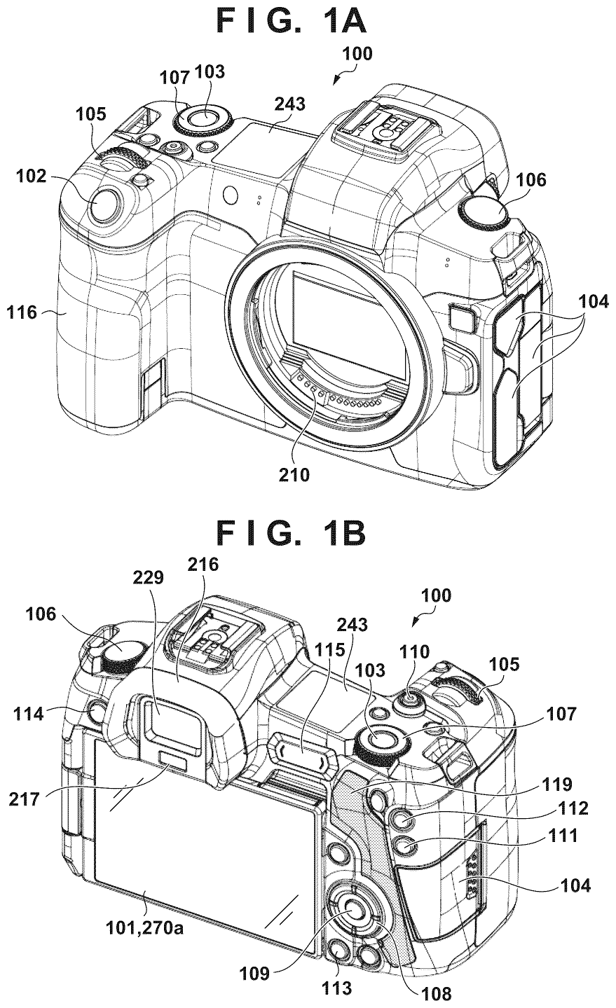

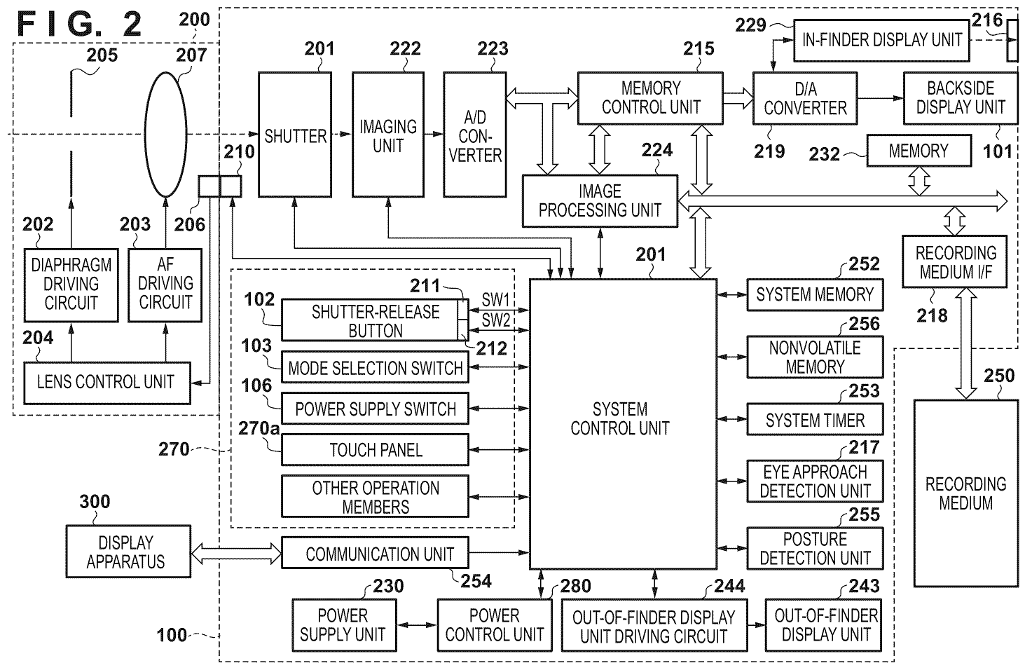

With reference to FIGS. 1A, 1B and 2, the configuration and functions of the digital camera 100 according to the present embodiment will be described.

FIG. 1A is a front perspective view of the digital camera 100 in a state where a lens unit 200 is detached. FIG. 1B is a back perspective view of the digital camera 100.

In FIGS. 1A and 1i, a backside display unit 101 is an out-of-finder display unit for displaying images and various types of information and a display device such as an LCD provided on the back surface of the camera body. Moreover, the backside display unit 101 has a function of reproducing a still image after the still image was shot, a function of displaying a moving image that is being recorded, and a live view display function as well. A touch panel (touch screen) 270a is provided on the backside display unit 101. The touch panel 270a is a touch operation member capable of detecting contact (touch operation) with the display surface (touch operation surface of the touch panel 270a) of the backside display unit 101.

An out-of-finder display unit 243 is a display device provided on the upper surface of the camera body, and displays various setting values of the camera such as a shutter speed and a diaphragm aperture. A shutter-release button 102 is an operation member for giving a shooting instruction. A mode selection switch 103 is a rotating dial type operation member for switching between various modes. A terminal cover 104 is a cover member for protecting a connector (not illustrated) for connecting an external apparatus and the digital camera 100 via a cable such as a USB cable. A main electronic dial 105 is a rotating operation member included in operation units 270 that will be described later with reference to FIG. 2, and by rotating this main electronic dial 105, setting values such as a shutter speed and a diaphragm aperture can be changed.

A power supply switch 106 is an operation member for switching between on/off of the power supply to the digital camera 100. A sub electronic dial 107 is a rotating operation member included in the operation units 270 that will be described later with reference to FIG. 2, and can move a selected frame, scroll images, and/or the like. A cross key 108 is also a movement instruction member included in the operation units 270 that will be described later with reference to FIG. 2, and is a four-directional operation button having push buttons that can be pressed in four directions of up, down, left, and right. The operation can be performed according to the portion of the cross key 108 pressed in the pressed direction. A SET button 109 is also a push button included in the operation units 270 that will be described later with reference to FIG. 2, and is mainly used for determining a selection item and/or the like.

A video recording button 110 is also included in operation units 270 that will be described later with reference to FIG. 2, and is used to instruct start and stop of moving image recording. An AE lock button 112 is also included in the operation units 270 that will be described later in FIG. 2, and can fix an exposure state by being pressed in a shooting standby state. An enlargement/reduction button 111 is also included in the operation units 270 that will be described later in FIG. 2, and is an operation button for turning on/off of an enlargement mode during a live view display in the shooting mode. By operating the main electronic dial 105 after turning on of the enlargement mode, the live view image can be enlarged or reduced. In the reproduction mode, the main electronic dial 105 functions as an enlargement button for enlarging a reproduced image and increasing an enlargement ratio.

A reproduction button 113 is also an operation button included in the operation units 270 that will be described later in FIG. 2, and is an operation button for switching the operation mode of the digital camera 100 to the shooting mode or the reproduction mode. By pressing the reproduction button 113 during the shooting mode, the operation mode is switched to the reproduction mode, and the latest image among the images recorded on the recording medium 250 can be displayed on the backside display unit 101. A menu button 114 is also included in the operation units 270 that will be described later in FIG. 2, and a menu screen on which various settings can be made can be displayed on the backside display unit 101 by pressing the menu button 114. The user can intuitively perform various settings using the menu screen displayed on the backside display unit 101, the cross key 108 and the SET button 109 or the touch bar 115.

A touch bar 115 (multi-function bar) is also included in the operation units 270 that will be described later in FIG. 2, and is a line-shaped touch operation member (line touch sensor) capable of accepting a touch operation. The touch bar 115 is arranged at a position that can be touched (touchable) by the thumb of the right hand while gripping a grip portion 116 with the right hand so that the shutter-release button 102 can be pressed with the index finger of the right hand (a state of gripping the grip portion with the little finger, the ring finger and the middle finger of the right hand). That is, the touch bar 115 is arranged at a position in which the user can operate the touch bar 115 in a state (shooting posture) where the user is looking through the viewfinder by contacting the eye with the eyepiece part 216 and can press the shutter-release button 102 at any time. The touch bar 115 is an acceptance unit capable of accepting a tap operation (an operation of touching and releasing the touch bar 115 without moving a touch position within a predetermined time period), a slide operation to the left and right (an operation of touching the touch bar 115 and moving a touch position while touching the touch bar 115), or the like. The touch bar 115 is an operation member which is different from the touch panel 270a and does not have a display function.

A grip portion 116 has a shape that makes it easy to be grasped by the right hand of the user when the user holds up the digital camera 100. The shutter-release button 102 and the main electronic dial 105 are arranged at positions where the grip portion 116 can be operated by the index finger of the right hand while holding the digital camera 100 by gripping the grip portion 116 with the little finger, the ring finger and the middle finger of the right hand. In the same state, the sub electronic dial 107 and the touch bar 115 are arranged at a position operable with the thumb of the right hand. A lid 117 is a member for opening or closing a slot for mounting/removing the recording medium 250 to/from the digital camera 100.

A communication terminal 210 is an electric contact point for the digital camera 100 to perform communication with the lens unit 200. The eyepiece part 216 is a look-through type eyepiece finder. The user can visually recognize an image displayed on an electronic viewfinder (EVF) which is the in-finder display unit 229 through the eyepiece part 216, and can confirm the focus and composition of the captured object image through the lens unit 200 that will be described later in FIG. 2.

An eye approach detection unit 217 is arranged near the eyepiece part 216, and can detect approach of any object to the eyepiece part 216. As the eye approach detection unit 217, for example, an infrared proximity sensor is used.

A thumb rest portion 119 (thumb waiting position) is a grip member on the back side of the digital camera 100, which is provided at a position where the thumb of the right hand that grips the grip portion 116 is easily placed in a state in which the user does not operate any operation member. The thumb rest portion 119 is comprised of a rubber member or the like for increasing a force for holding the digital camera 10 (grip feeling).

Next, with reference to FIG. 2, the internal configuration of the digital camera 100 and the lens unit 200 of the present embodiment will be described. In FIG. 2, components that are the same as those in FIGS. 1A and 1B are denoted by the same reference numerals.

In FIG. 2, the lens unit 200 is equipped with a shooting lens 207, and is detachable from the digital camera 100. The shooting lens 207 is usually constituted by a plurality of lenses, but is simplified here and is shown by one lens. A communication terminal 206 is an electric contact point for the lens unit 200 to perform communication with the digital camera 100. The communication terminal 210 is an electric contact point for the digital camera 100 to perform communication with the lens unit 200. The lens unit 200 performs communication with a system control unit 201 via the communication terminal 206, and a built-in lens control unit 204 controls a diaphragm driving circuit 202 so as to drive a diaphragm aperture 205, and controls an AF driving circuit 203 so as to displace the position of the shooting lens 207, thereby bringing the object image in focus.

A focal plane shutter 221 can freely control the exposure time of an imaging unit 222 in accordance with an instruction from the system control unit 201. The imaging unit 222 is an image sensor constituted by an image capturing element such as a CCD or a CMOS for converting the object image into an electrical signal. An A/D converter 223 converts an analog signal output from the imaging unit 222 into a digital signal.

An image processing unit 224 performs resizing processing, such as predetermined pixel interpolation and reduction, and color conversion processing, with respect to data from the A/D converter 223 or data from a memory control unit 215. Further, the image processing unit 224 performs predetermined arithmetic processing using the captured image data, and the system control unit 201 performs exposure control and focus control based on the arithmetic results. Thus, AF (Automatic Focus) processing, AE (Automatic Exposure) processing, and EF (flash pre-emission) processing of TTL (Through the Lens) type are performed. Furthermore, the image processing unit 224 performs predetermined arithmetic processing using the captured image data, and AWB (Automatic White Balance) processing of TTL type is performed on the basis of the arithmetic results.

A memory control unit 215 controls to exchange data between the A/D converter 223, the image processing unit 224, and a memory 232. Digital data output from the A/D converter 223 is directly written into the memory 232 via both the image processing unit 224 and the memory control unit 215 or via the memory control unit 215. The memory 232 stores image data obtained from the imaging unit 222 and the A/D converter 223, and display data for displaying the image on the backside display unit 101 or the in-finder display unit 229. The memory 232 has a storage capacity that is sufficient for storing a predetermined number of still images as well as moving images and audio of a predetermined time period. The memory 232 also functions as a memory for image display (video memory).

A D/A converter 219 converts the display data for the image stored in the memory 232 into an analog signal and supplies the backside display unit 101 or the in-finder display unit 229 with the analog signal. The display data for the image that was written into the memory 232 is displayed by the backside display unit 101 or the in-finder display unit 229 via the D/A converter 219. The backside display unit 101 and the in-finder display unit 229 display on the display device in accordance with the analog signal from the D/A converter 219. In this manner, the digital signals stored in the memory 232 are converted into analog signals, and the analog signals are successively transmitted to the backside display unit 101 or the in-finer display unit 229 so as to be displayed thereon, making it possible to function as an electronic view finder (EVF) and to perform live view (LV) display (through-the lens image display).

Various setting values of the camera such as a shutter speed and the diaphragm aperture are displayed on the out-of-finder display unit 243 via an out-of-finder display unit driving circuit 244.

A nonvolatile memory 256 is an electrically erasable/recordable memory, and for example, a flash ROM or the like is used. In the nonvolatile memory 256, constants and programs, for example, for operating the system control unit 201 are stored. In this context, “programs” may refer to programs for executing flowcharts that will be described later.

The system control unit 201 is an arithmetic processing device including at least one processor and/or at least one circuit, overall controlling the entire digital camera 100. The system control unit 201 realizes, by executing the programs stored in the nonvolatile memory 256, each process of the flowchart that will be described later. As a system memory 252, for example, RAM is used, and the system memory 252 is used also as a work memory where constants and variables for operating the system control unit 201 and the programs read out from the nonvolatile memory 256 are loaded. The system control unit 201 controls the memory 232, the D/A converter 219, the backside display unit 101, the in-finder display unit 229, and/or the like, so as to perform display control. A system timer 253 is a time measurement unit for measuring time periods for various types of controls and the time of an inner clock.

The mode selection switch 103, a first shutter switch 211, a second shutter switch 212, and the operation units 270 are operation devices for inputting various types of operating instructions to the system control unit 201. The mode selection switch 103 switches the operation mode of the system control unit 201 to any of a still image shooting mode, a moving image recording mode, and a reproduction mode. The still image shooting mode includes an automatic shooting mode, an automatic scene discrimination mode, a manual mode, an aperture-priority mode (Av mode), a shutter speed-priority mode (Tv mode), and a program AE mode (P mode), for example. The still image shooting mode also includes various scene modes each for which scene-specific shooting setting is made, a custom mode, and/or the like.

The user may directly switch to any of these shooting modes by operating the mode selection switch 103, or may switch to any of the shooting modes using another operation member after once being switched to a list screen of the operation modes with the mode selection switch 103 and selecting any of the plurality of shooting modes displayed in the list screen. Similarly, also the moving image recording mode and the reproduction mode may include a plurality of modes.

While the shutter-release button 102 provided on the digital camera 100 is being operated, that is, pressed halfway (the shooting preparation instruction), the first shutter switch 211 is turned on and generates a first shutter switch signal SW1. Upon receiving the first shutter switch signal SW1, the system control unit 201 starts shooting preparation operations such as AF (automatic focus) processing, AE (auto exposure) processing, AWB (auto white balance) processing, and EF (flash pre-emission) processing.

When the operation of the shutter-release button 102 is completed, that is, the shutter-release button 102 is pressed fully (the shooting instruction), the second shutter switch 212 is turned on and generates a second shutter switch signal SW2. Upon receiving the second shutter switch signal SW2, the system control unit 201 starts a series of shooting processing from reading out the signals from the imaging unit 222 to writing of the captured image data as an image file to the recording medium 250.

The operation units 270 include operation members such as various switches and buttons for accepting various operations from a user, and notifying the system control unit 201 of the accepted operations, and include at least the following operation members: the shutter-release button 102, the mode selection switch 103, the main electronic dial 105, the power supply switch 106, the sub electronic dial 107, the cross key 108, the SET button 109, the video recording button 110, the enlargement/reduction button 111, the AE lock button 112, the reproduction button 113, the menu button 114 and the touch bar 115.

A power control unit 280 is constituted by, for example, a battery detection circuit, a DC-DC converter, and a switch circuit for changing over the block to be supplied with power, and detects whether a battery has been inserted or not, the type of the battery, and the residual capacity thereof. Further, the power control unit 280 controls the DC-DC converter in accordance with the detection results and an instruction of the system control unit 201, and supplies a necessary voltage for a necessary length of time to each component including the recording medium 250.

A power supply unit 230 comprises a primary battery such as an alkaline battery or a lithium battery, and a secondary battery such as a NiCd battery, a NiMH battery, or a Li-ion battery, or an AC adaptor. A recording medium interface (I/F) 218 is for interfacing with the recording medium 250 such as a memory card or a hard disk drive. The recording medium 250 is a recording medium such as a memory card for recording shot images, and is constituted by a semiconductor memory, a magnetic disk, or the like.

A communication unit 254 connects an external apparatus so as to be capable of communication by a wireless antenna or a wired cable, and transmits and receives images and/or sounds. The communication unit 254 can also connect to a wireless LAN (Local Area Network) and the Internet. The communication unit 254 can transmit image data (including a live view image) captured by the imaging unit 222 and an image file recorded on the recording medium 250 to an external apparatus, and can receive image data or other various information from the external apparatus. Note that in the present embodiment, the communication unit 254 has a connection unit which complies with an HDMI®. The display apparatus 300 connected to the communication unit 254 by an HDMI cable can display a live view image captured by the imaging unit 222 and images recorded on the recording medium 250. Note that the communication unit 254 is not limited to the wireless LAN, but may use a wireless communication module such as an infrared communication, Bluetooth®, Bluetooth® Low Energy or Wireless USB, or the like.

A posture detection unit 255 detects the posture of the digital camera 100 with respect to the gravity direction. Based on the posture detected by the posture detection unit 255, it is possible to discriminate whether an image captured by the imaging unit 222 has been shot by setting the digital camera 100 in the landscape or portrait orientation. The system control unit 201 can add information about the posture information corresponding to the posture detected by the posture detection unit 255 to the image file, and rotate and record the captured image. An acceleration sensor, gyro sensor or the like may be used as the posture detection unit 255. The posture detection unit 255 can also detect the movement (pan, tilt, lift, rest, etc.) of the digital camera 100 by using the acceleration sensor or the gyro sensor.

Included among the operation units 270 is also the touch panel 270a that is capable of detecting a touch operation on the backside display unit 101. The touch panel 270a and the backside display unit 101 can be constructed as a single integrated unit. For example, the touch panel 270a is constructed in such a manner that the transmittance of light will not interfere with the display presented by the backside display unit 101, and it is attached to the uppermost layer of the display face of the backside display unit 101. In addition, input coordinates on the touch panel 270a and display coordinates on the backside display unit 101 are correlated. As a result, a GUI can be constructed so as to make it possible for the user to directly manipulate the screen displayed on the backside display unit 101. The system control unit 201 is capable of detecting taps, double taps, drags, flicks, pinch-ins, pinch-outs, swipes, etc. onto the touch panel 270a. The touch panel 270a may employ a method that relies upon any of the following: resistive film, electrostatic capacitance, surface acoustic waves, infrared radiation, electromagnetic induction, image recognition and optical sensing. There are methods in which a touch is detected based on contact with the touch panel, as well as methods in which a touch is detected based on approach of a finger or a pen to the touch panel, and any method may be employed.

The eye approach detection unit 217 detects whether an eye (an object) has approached or contacted (eye approaching) or has moved away from (eye detached) the eyepiece part 216 (approach detection). The system control unit 201 switches the backside display unit 101 and the in-finder display unit 229 between displaying (a display state) and not displaying (a non-display state) in accordance with the state detected by the eye approach detection unit 217. The system control unit 201 sets a display destination as the backside display unit 101 and sets the in-finder display unit 229 to be not displaying during non-eye approach detection at least in a case where the shooting mode and the switching of the display destination are automatic. Further, the system control unit 201 sets the display destination as the in-finder display unit 229 and sets the backside display unit 101 to be not displaying during eye approach detection.

If an object has approached, infrared light irradiated from a light emitting unit (not illustrated) of the eye approach detection unit 217 is reflected and is made to be incident on a light receiving unit (not illustrated) of the infrared proximity sensor. In accordance with an incident light amount of the infrared light received by the infrared proximity sensor, it is possible to detect an approach of some kind of physical object to the eyepiece part 216, and discriminate to what level of distance the object has gotten close to the eyepiece part 216 (an eye approaching distance). Upon detecting an approach of an object to the eyepiece part 216, the system control unit 201 can cause display of the in-finder display unit 229 to start. With this, it is possible for the in-finder display unit 229 to display without delay as much as possible when a user looks through the eyepiece part 216.

In addition, upon detecting that an object has approached within a predetermined distance with respect to the eyepiece part 216 from a non-eye approaching state (no approach state), the eye approach detection unit 217 determines that eye approaching is detected and transmits an eye approach detection notification to the system control unit 201. In addition, if an object for which an approach was detected is apart by the predetermined distance or more from an eye approaching state (approach state), the eye approach detection unit 217 determines that eye separation is detected, and an eye separation detection notification is transmitted to the system control unit 201. A threshold for detecting eye approaching and a threshold for detecting eye separation may be made different such as by providing hysteresis for example. In addition, it is assumed that, after eye approaching is detected, there is an eye approaching state until eye separation is detected. In addition, it is assumed that, after eye separation is detected, there is a non-eye approaching state until eye approaching is detected. With this, the system control unit 201 performs display control of the backside display unit 101 and the in-finder display unit 229 in response to an eye approaching state or an eye separation state detected by the eye approach detection unit 217.

Note that the eye approach detection unit 217 is not limited to an infrared proximity sensor, and another sensor may be used if it can detect an approach of an object or an eye to be deemed as eye approaching.

### First Embodiment

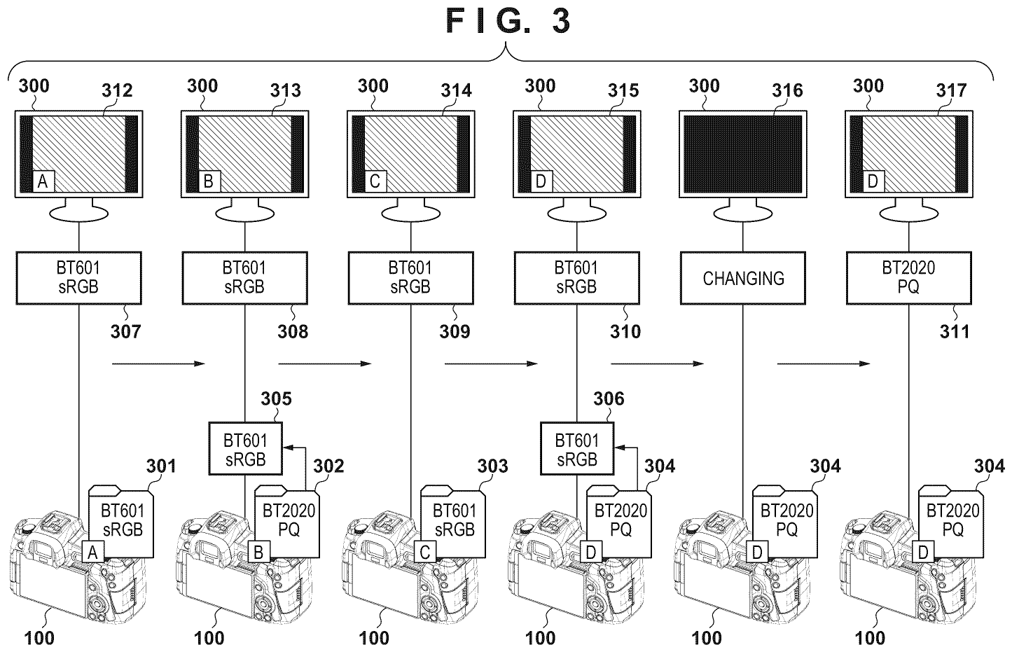

The first embodiment will be described next with reference to FIGS. 3 to 5.

The first embodiment will describe an example in which setting information (connection settings) concerning content display characteristics set in a digital camera 100 and a display apparatus 300 is not changed while content is continuously changed, and the connection settings are changed in accordance with the display characteristics of the reproduction target content when the continuous change of the content is stopped.

FIG. 3 is a view illustrating transition of information concerning content display characteristics set in the digital camera 100 and the display apparatus 300 when continuously reproducing a plurality of content according to the first embodiment.

The digital camera 100 and the display apparatus 300 are connected by an HDMI cable. By connecting one end of the HDMI cable to a connector arranged in the terminal cover 104 of the digital camera 100 and connecting the other end of the HDMI cable to the video input terminal of the display apparatus 300, it is possible to display content generated by the digital camera 100 on the display apparatus 300. If the communication unit 254 of the digital camera 100 is connected to the display apparatus 300 by the HDMI cable, it is possible to change the HDMI connection settings. The present embodiment will describe an example of switching between the HDMI connection settings of a color gamut of BT601 and a gamma characteristic of sRGB and the HDMI connection settings of a color gamut of BT2020 and a gamma characteristic of PQ in accordance with the display characteristics of content transmitted to and displayed on the display apparatus 300. Note that the connection settings may be switched connection settings other than the above connection settings in accordance with the content display characteristics. In the present embodiment, the reproduction button 113 is pressed to switch to the reproduction mode, thereby reproducing the content recorded on the recording medium 250. Note that the content of the present embodiment is, for example, a moving image or a still image but is not limited to this, and may be content other than the images.

The user can set, as a reproduction target content (to be also referred to as a reproduction content hereinafter), content sequentially selected in accordance with the rotation direction by rotating the sub electronic dial 107 in the clockwise direction or the counterclockwise direction. Furthermore, the user can continuously change the reproduction content by continuously rotating the sub electronic dial 107. In the present embodiment, first content 301 is reproduced first as the reproduction content selected by the sub electronic dial 107. Subsequently, by continuously rotating the sub electronic dial 107 in the clockwise direction, the reproduction content is continuously changed to second content 302, third content 303, and fourth content 304, and then the rotation operation of the sub electronic dial 107 is stopped.

In each of content 301 to 304, characteristic information concerning the color gamut and the gamma characteristic of each of content 301 to 304 is recorded. Each of the first content 301 and the third content 303 is Standard Dynamic Range (SDR) content in which BT601 as a color gamut and sRGB as a gamma characteristic are recorded in a file format such as a JPEG format. Each of the second content 302 and the fourth content 304 is High Dynamic Range (HDR) content in which BT2020 as a color gamut and PQ as a gamma characteristic are recorded in a file format such as a HEIF format.

First connection settings 307 are information concerning the content display characteristics set in the digital camera 100 and the display apparatus 300 when the display apparatus 300 reproduces the first content 301, and information including the color gamut and gamma characteristic. The color gamut and gamma characteristic of the first connection settings 307 are BT601 and sRGB, and the display apparatus 300 is set to a mode in which the first content 301 can be displayed based on the color gamut and gamma characteristic of the first connection settings 307. Since the color gamut and gamma characteristic of the first connection settings 307 match those of the first content 301, the display apparatus 300 can faithfully display the color and brightness of the first content 301. A first display result 312 is the reproduction result of the first content 301 displayed on the display apparatus 300.

Second connection settings 308 are information concerning the content display characteristics set in the digital camera 100 and the display apparatus 300 when the display apparatus 300 reproduces the second content 302. The color gamut and gamma characteristic of the second content 302 are BT2020 and PQ. Therefore, by making the color gamut and gamma characteristic of the second connection settings 308 match those of the second content 302, the display apparatus 300 can faithfully display the color and brightness of the second content 302. However, in the present embodiment, to suppress flickering of a screen at the time of content reproduction, caused by changing the connection settings of the digital camera 100 and the display apparatus 300, the connection settings are maintained without any change when the reproduction content is continuously changed. Thus, the color gamut and gamma characteristic of the second connection settings 308 are maintained to be BT601 and sRGB, similar to the first connection settings 307. The case where the reproduction content is continuously changed is, for example, a case where the rotation amount of the sub electronic dial 107 per unit time exceeds a threshold. In this case, the color gamut and gamma characteristic of the second content 302 do not match those of the second connection settings 308. Therefore, the color and brightness of the second content 302 displayed on the display apparatus 300 are different from those of the original content, and it may be difficult for the user to visually perceive the content depending on the content. To cope with this, in the present embodiment, conversion processing of the color gamut and gamma characteristic of the second content 302 generated by the digital camera 100 is performed according to the color gamut and gamma characteristic of the second connection settings 308. Fifth content 305 is content obtained by converting the color gamut and gamma characteristic of the second content 302 into T601 and sRGB as the color gamut and gamma characteristic of the second connection settings 308. The ranges of color and brightness that can be expressed by BT601 and sRGB as the color gamut and gamma characteristic are narrower than in a case of BT2020 and PQ as the color gamut and gamma characteristic. Therefore, proper mapping is performed so that the color and brightness fall within the ranges of BT601 and sRGB although the color and brightness of the second content 302 are not faithfully expressed. A second display result 313 is the reproduction result of the second content 302 (fifth content 305) displayed on the display apparatus 300. The color gamut and gamma characteristic of the fifth content 305 match those of the second connection settings 308. Thus, the color and brightness of the fifth content 305 obtained by converting the color gamut and gamma characteristic of the second content 302 based on the color gamut and gamma characteristic of the second connection settings 308 are faithfully displayed on the display apparatus 300.

Third connection settings 309 are information concerning the content display characteristics set in the digital camera 100 and the display apparatus 300 when the display apparatus 300 reproduces the third content 303. Similar to the case where the first content 301 is reproduced, the color gamut and gamma characteristic of the third connection settings 309 match those of the third content 303. Therefore, the display apparatus 300 can faithfully display the color and brightness of the third content 303 without performing conversion processing of the color gamut and gamma characteristic, unlike the second content 302. A third display result 314 is the reproduction result of the third content 303 displayed on the display apparatus 300.

Fourth connection settings 310 are information concerning the content display characteristics set in the digital camera 100 and the display apparatus 300 when the display apparatus 300 reproduces the fourth content 304. Similar to the case where the second content 302 is reproduced, BT2020 and PQ as the color gamut and gamma characteristic of the fourth content 304 do not match BT601 and sRGB as the color gamut and gamma characteristic of the fourth connection settings 310. Therefore, to suppress flickering of a screen at the time of content reproduction, conversion processing of the color gamut and gamma characteristic of the fourth content 304 is performed according to the color gamut and gamma characteristic of the fourth connection settings 310. Sixth content 306 is content obtained by converting the color gamut and gamma characteristic of the fourth content 304 into T601 and sRGB as the color gamut and gamma characteristic of the fourth connection settings 310. A fourth display result 315 is the reproduction result of the fourth content 304 (sixth content 306) displayed on the display apparatus 300.

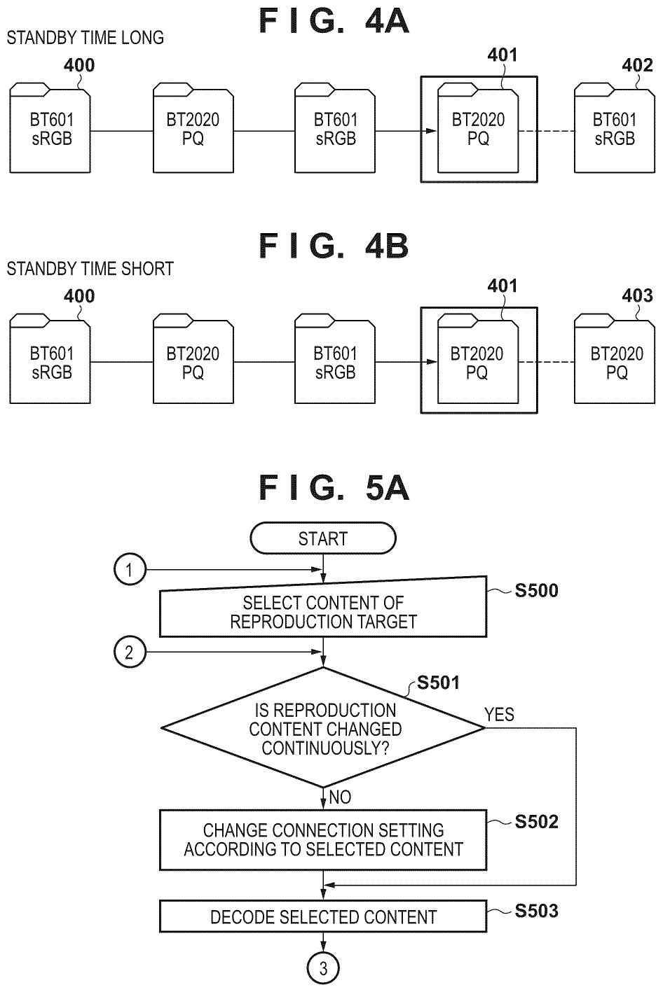

When the fourth display result 315 is displayed on the display apparatus 300, the user stops the rotation operation of the sub electronic dial 107, thereby ending the selection and change of the reproduction content. In this case, the digital camera 100 determines whether there are differences between the color gamut and gamma characteristic of the selected content (to be also referred to as selection content hereinafter) and those of the connection settings. A standby time from when the user stops the rotation operation of the sub electronic dial 107 until the differences between the selection content and the connection settings are confirmed will be described later with reference to FIGS. 4A and 4B. In the present embodiment, there are differences in the color gamut and gamma characteristic between the fourth content 304 and the fourth connection settings, and thus the color gamut and gamma characteristic of the connection settings are changed to match those of the selection content. A fifth display result 316 indicates the display state of the display apparatus 300 while the connection settings are changed, and the screen is in a blackout state without displaying the reproduction content.

Fifth connection settings 311 are connection settings obtained by changing the color gamut and gamma characteristic to match those of the fourth content 304. A sixth display result 317 is the display result of the display apparatus 300 in a case where the color gamut and gamma characteristic are changed to match those of the fourth content 304. Since the color gamut and gamma characteristic of the fourth content 304 match those of the fifth connection settings 311, the display apparatus 300 can faithfully display the color and brightness of the fourth content 304.

FIGS. 4A and 4B are views illustrating control of the standby time from when the continuous change of the reproduction content is stopped until the color gamut and gamma characteristic of the connection settings are changed to those of the selection content. As described with reference to FIG. 3, in the present embodiment, when the user stops the rotation operation of the sub electronic dial 107, it is confirmed whether there are differences in the color gamut and gamma characteristic between the selection content and the connection settings at this time. In this case, the standby time until differences in the color gamut and gamma characteristic between the selection content and the connection settings are confirmed is determined, as follows.

FIG. 4A exemplifies a case where the color gamut and gamma characteristic of the selection content are different from those of a selection candidate content that may have been selected next when the change of the reproduction content is stopped. Content 400 at the start of the change is selection content when the user starts the rotation operation of the sub electronic dial 107. The color gamut and gamma characteristic of the content 400 are BT601 and sRGB, and the connection settings of the digital camera 100 and the display apparatus 300 at this time are the same. After that, the user continues the rotation operation of the sub electronic dial 107, and the connection settings during this operation are maintained to be BT601 and sRGB regardless of the color gamut and gamma characteristic of the selection content. Content 401 at the stop of the change is selection content when the user stops the rotation operation of the sub electronic dial 107. The color gamut and gamma characteristic of the content 401 are BT2020 and PQ. A selection candidate content 402 is content that may have been selected next when the user stops the rotation operation of the sub electronic dial 107. The color gamut and gamma characteristic of the selection candidate content 402 are BT601 and sRGB, and are different from BT2020 and PQ of the content 401 at the stop of the change. When the continuous change of the content is stopped, if the color gamut and gamma characteristic of the content 401 at the stop of the change are different from those of the selection candidate content that may have been selected next, the standby time until the differences in the color gamut and gamma characteristic between the content and the connection settings are determined is set longer than the standby time in a case (FIG. 4B) where the color gamut and gamma characteristic of the content 401 at the stop of the change match those of the selection candidate content that may have been selected next. This is processing on the premise that the timing when the user stops the rotation operation of the sub electronic dial 107 is incorrect. In the present embodiment, assume that the user wanted to stop the sub electronic dial 107 at the selection candidate content A 402 but unwantedly stopped the sub electronic dial 107 at the preceding content 401 at the stop of the change. A grace time until the user corrects the error to change the content again is prolonged.

FIG. 4B exemplifies a case where the color gamut and gamma characteristic of the selection content match those of a selection candidate content that may have been selected next when the change of the reproduction content is stopped. Selection candidate content B 403 is content that may have been selected next when the user stops the rotation operation of the sub electronic dial 107. The color gamut and gamma characteristic of the selection candidate content B 403 are BT2020 and PQ, and match those of the content 401 at the time of stop of the change. In this case, even if the timing when the user stops the sub electronic dial 107 is too early, the color gamut and gamma characteristic of the content remain BT2020 and PQ. Therefore, the standby time until the differences in the color gamut and gamma characteristic between the selection content and the connection settings are determined is not extended.

Note that in the present embodiment, when the continuous change of the content is stopped, the selection candidate content that may have been selected next is focused on. However, by assuming a case where the timing when the user stops the rotation operation of the sub electronic dial 107 is too late, content preceding to the selection candidate content may be focused on. Alternatively, one of content preceding to the selection candidate content and content succeeding to the selection candidate content, or both of them may be focused on.

### <Control Processing>

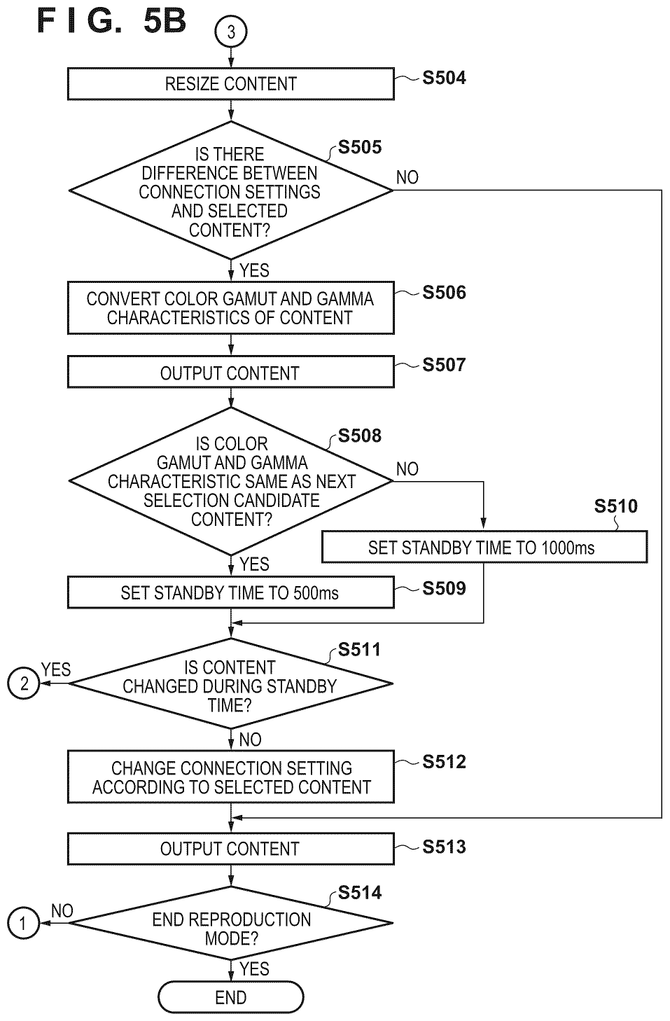

The display control processing of the digital camera 100 according to the present embodiment will be described next with reference to FIG. 5.

The processing shown in FIGS. 5A and 5B is implemented when the system control unit 201 controls the respective components of the digital camera 100 by deploying programs stored in the nonvolatile memory 256 to the system memory 252 and executing the programs. The processing shown in FIGS. 5 A and 5B is started when the digital camera 100 is powered on and the operation mode of the system control unit 201 is set to the reproduction mode.

In step S500, the system control unit 201 accepts an operation to select reproduction content by the user. The system control unit 201 detects the rotation of the sub electronic dial 107, and determines reproduction content from content recorded on the recording medium 250 in accordance with the rotation direction.

In step S501, the system control unit 201 determines whether the reproduction content is continuously changed. The system control unit 201 determines whether the sub electronic dial 107 is rotated at a predetermined frequency or higher. When the system control unit 201 determines that the reproduction content is not continuously changed (NO in step S501), it advances the process to step S502. When the system control unit 201 determines that the reproduction content is continuously changed (YES in step S501), it advances the process to step S503 without changing the connection settings in step S502.

In step S502, the system control unit 201 changes the connection settings of the digital camera 100 and the display apparatus 300 according to the color gamut and gamma characteristic of the selection content.

In step S503, the system control unit 201 decodes the selection content. The image processing unit 224 decodes the content data encoded in a format such as a JPEG format, and arranges the data in a predetermined format such as a YUV format in the memory 232.

In step S504, the system control unit 201 resizes the content data decoded in step S503 in accordance with the resolution of the display apparatus 300. The decoding result obtained in step S503 has the same width and height as those at the time of content generation, and thus the size is changed to match the width and height of the resolution of the display apparatus 300. For example, if the display apparatus 300 can display a full HD image, the width and height are 1,920 and 1,080, respectively, and if the display apparatus 300 can display a 4K resolution image, the width and height are 3,840 and 2,160, respectively. This resizing result is arranged in the memory 232.

In step S505, the system control unit 201 determines whether there are differences in the color gamut and gamma characteristic between the selection content and the connection settings. When the content connection settings have been changed in step S502 or when the content selected by the user accidentally matches the current connection settings (NO in step S505), the system control unit 201 advances the process to step S513. When the system control unit 201 determines that there are differences in the color gamut and gamma characteristic between the selection content and the connection settings (YES in step S505), it advances the process to step S506.

In step S506, the system control unit 201 converts the color gamut and gamma characteristic of the content data resized in step S504 according to the connection settings of the current content.

In step S507, the system control unit 201 transmits, to the display apparatus 300, the content data obtained by converting the color gamut and gamma characteristic in step S506.

In step S508, the system control unit 201 determines whether the color gamut and gamma characteristic of the current content match those of the next selection candidate content. When the system control unit 201 determines that the color gamut and gamma characteristic of the current content match those of the next selection candidate content (YES in step S508), it advances the process to step S509, and sets the standby time to 500 msec. When the system control unit 201 determines that the color gamut and gamma characteristic of the current content do not match those of the next selection candidate content (NO in step S508), it advances the process to step S510, and sets the standby time to 1,000 msec.

In step S511, the system control unit 201 determines whether the user changes the reproduction content before the standby time set in step S509 or S510 elapses. When the system control unit 201 determines that the reproduction content is changed during the standby time (YES in step S511), it returns the process to step S501, and performs the processes of step S501 and the subsequent steps for the newly selected content. When the system control unit 201 determines that the reproduction content is not changed during the standby time (NO in step S511), it advances the process to step S512.

In step S512, the system control unit 201 changes the connection settings of the digital camera 100 and the display apparatus 300 according to the color gamut and gamma characteristic of the selection content.

In step S513, the system control unit 201 transmits the content data resized in step S504 to the display apparatus 300. Note that the resized content data is content before conversion of the color gamut and gamma characteristic is performed in step S506, and is transmitted to the display apparatus 300 while maintaining the color gamut and gamma characteristic of the selection content.

In step S514, the system control unit 201 determines whether to end the reproduction mode. The system control unit 201 determines whether the user performs an operation of ending the reproduction mode such as the pressing of the reproduction button 113. When the system control unit 201 determines to end the reproduction mode (YES in step S514), it ends the processing. When the system control unit 201 determines not to end the reproduction mode (NO in step S514), it returns the process to step S500, and stands by until the user selects the next content.

According to the first embodiment, when the plurality of content each of which has different color gamuts and gamma characteristics are reproduced while continuously changing them, it is possible to suppress flickering of a screen because the connection settings of the digital camera 100 and the display apparatus 300 are not changed and no reconnection is performed. In addition, when the continuous change of the content is ended, the connection settings of the digital camera 100 and the display apparatus 300 are changed in accordance with the color gamut and gamma characteristic of the reproduction target content, thereby making it possible to faithfully display the color and brightness of the content.

Note that the present embodiment has explained an example of focusing on the color gamuts and gamma characteristics of the content and the connection settings. However, the connection settings may be controlled by focusing on other elements concerning a video, such as a data range, a frame rate, and a resolution.

### Second Embodiment

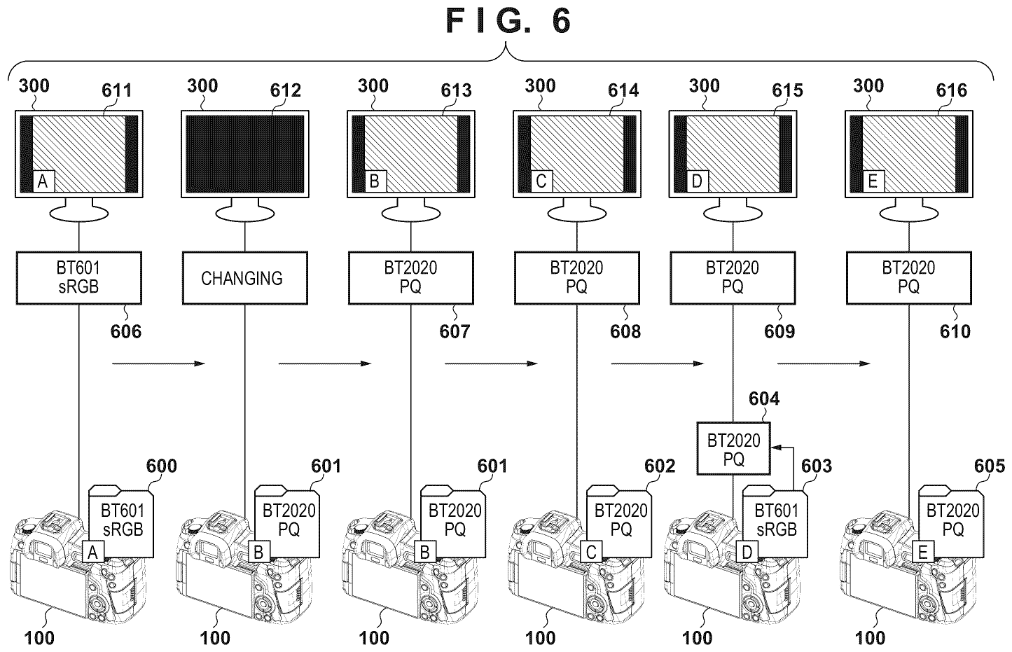

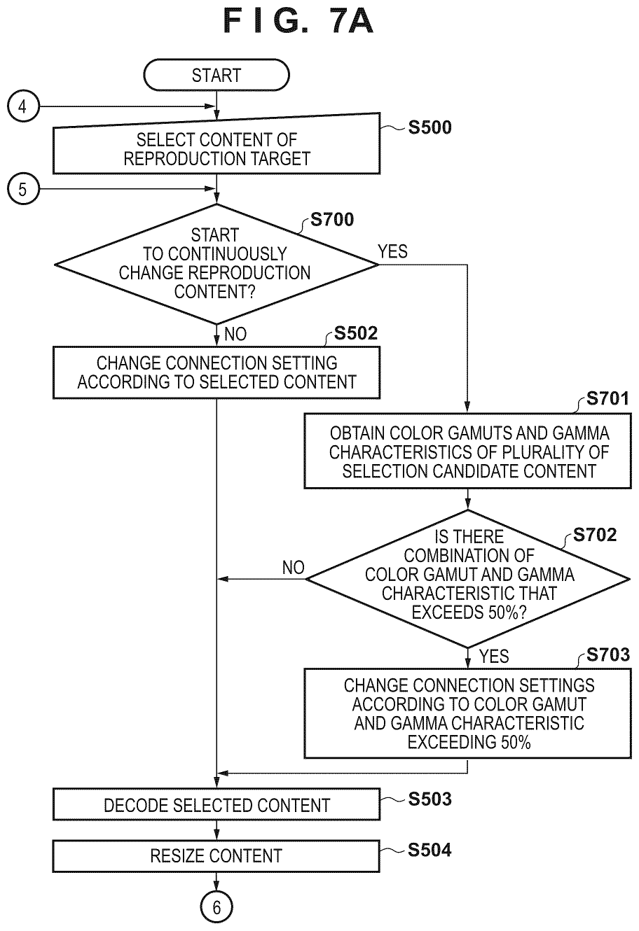

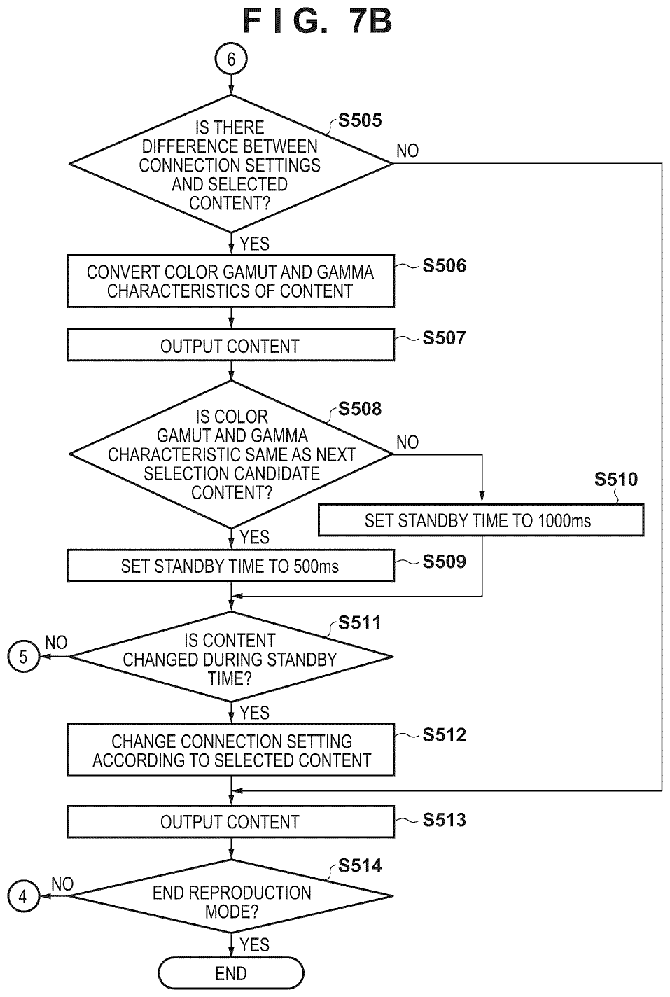

The second embodiment will be described next with reference to FIGS. 6 and 7.

The second embodiment will describe an example in which connection settings are changed when a user starts to continuously change reproduction content, and the frequency of changing the connection settings after the continuously change of the content is stopped is reduced to quickly reproduce the content.

FIG. 6 is a view showing transition of the connection settings when continuously changing reproduction content according to the second embodiment.

First content 600 is content selected first as reproduction content by the user, and the color gamut and gamma characteristic of the first content 600 are BT601 and sRGB. First connection settings 606 are connection settings when reproducing the first content 600, and the color gamut and gamma characteristic of the first connection settings 606 are BT601 and sRGB that match those of the first content 600. A first display result 611 is a display result when the first content 600 is displayed on a display apparatus 300.

Assume here that the user rotates a sub electronic dial 107 to start to continuously change the reproduction content. In this case, with respect to a plurality of selection candidate content corresponding to the direction in which the user rotates the sub electronic dial 107, the color gamut and gamma characteristic of each piece of content are obtained. In a case where a ratio of content of a specific combination of the color gamut and gamma characteristic is equal to or higher than a predetermined ratio (for example, 50%), the connection settings are changed to the specific color gamut and gamma characteristic.

In the example shown in FIG. 6, the color gamut and gamma characteristic of each of second content 601, third content 602, and fifth content 605 are BT2020 and PQ, and the color gamut and gamma characteristic of only fourth content 603 are BT601 and sRGB. Since the ratio of the content of the combination of BT2020 and PQ exceeds 50%, the connection settings are changed. A second display result 612 indicates the display state of the display apparatus 300 while the connection settings are changed, and the whole screen is in a blackout state.

Second connection settings 607 are connection settings when the second content 601 is reproduced. Third connection settings 608 are connection settings when the third content 602 is reproduced. Furthermore, fifth connection settings 610 are connection settings when the fifth content 605 is reproduced. These connection settings are changed to BT2020 and PQ when the user starts to continuously change the reproduction content, as described above, and maintained. Similarly, the color gamut and gamma characteristic of fourth connection settings 609 are also BT2020 and PQ, but the color gamut and gamma characteristic of the fourth content 603 that is a reproduction target at this time are BT601 and sRGB. Even if there are differences in the color gamut and gamma characteristic between the reproduction content and the connection settings, the connection settings that have been changed first are maintained while the reproduction content is continuously changed, and the color gamut and gamma characteristic of the connection settings are BT2020 and PQ. Converted third content 604 is content obtained by converting the color gamut and gamma characteristic of the third content 602 according to those of the fourth connection settings 609. This displays, as a fifth display result 615, a reproduction result obtained by converting the color gamut and gamma characteristic of the fourth content 603 into BT2020 and PQ. On the other hand, as each of a third display result 613, a fourth display result 614, and a sixth display result 616, a reproduction result is displayed with BT2020 and PQ as the color gamut and gamma characteristic of the reproduction content.

FIGS. 7A and 7B are flowcharts illustrating the display control processing of a digital camera 100 according to the second embodiment.

In the processing shown in FIGS. 7A and 7B, processes that are the same as those in FIGS. 5A and 5B of the first embodiment are denoted by the same step numbers.

In step S500, a system control unit 201 accepts an operation to select reproduction content by the user.

In step S700, the system control unit 201 determines whether the user has started to continuously change the reproduction content. When the system control unit 201 determines that the user has not started to continuously change the reproduction content (NO in step S700), it performs the same processes as those in steps S502 to S514 of FIG. 5. When the system control unit 201 determines that the user has started to continuously change the reproduction content (YES in step S700), it advances the process to step S701.

In step S701, the system control unit 201 obtains the color gamuts and gamma characteristics of up to 10 selection candidate content in the change direction of the content. The change direction of the content indicates a direction (clockwise direction or counterclockwise direction) in which the sub electronic dial 107 is rotated, and the system control unit 201 obtains the color gamuts and gamma characteristics of the contents that can be selection candidates when the user continuously rotates the sub electronic dial 107. In the present embodiment, the total number of selection candidate contents is up to 10. However, the present invention is not limited to this and another number may be set as a maximum value.

In step S702, the system control unit 201 determines whether there is a combination of the color gamut and gamma characteristic, whose ratio exceeds 50%, among the color gamuts and gamma characteristics of the selection candidate contents obtained in step S701. Note that a ratio other than 50% may be adopted. When the system control unit 201 determines that there is no combination of the color gamut and gamma characteristic, whose ratio exceeds 50% (NO in step S702), it advances the process to step S503. When the system control unit 201 determines that there is a combination of the color gamut and gamma characteristic, whose ratio exceeds 50% (YES in step S702), it advances the process to step S703.

In step S703, the system control unit 201 changes the connection settings to the combination of the color gamut and gamma characteristic, whose ratio exceeds 50%, and advances the process to step S503. When the connection settings are changed in step S703, the probability of determining in step S505 that there are no differences in the color gamut and gamma characteristic between the selection content and the connection settings (NO in step S505) becomes high. This can reduce the frequency of conversion processing of the color gamut and gamma characteristic in step S506 or processing of changing the connection settings in step S512.

According to the second embodiment, when the plurality of content each of which has different color gamuts and gamma characteristics are reproduced while continuously changing them, it is possible to suppress flickering of a screen because the connection settings of the digital camera 100 and the display apparatus 300 set at the start of continuous change of reproduction target content are maintained and no reconnection is performed. In addition, when the continuous change of the content is ended, it is possible to reduce the frequency of changing the connection settings of the digital camera 100 and the display apparatus 300 in accordance with the color gamut and gamma characteristic of the reproduction target content and the frequency of converting the color gamut and gamma characteristic of the content in accordance with the connection settings of the digital camera 100 and the display apparatus 300. This can also reduce the frequency of reconnection when the continuous change of the content is ended, and thus suppress flickering of a screen, thereby faithfully displaying the color and brightness of the content.

### Modifications

(i) The second embodiment has explained an example in which when the user starts to continuously change the reproduction content, the connection settings are changed in accordance with the content corresponding to the rotation direction of the sub electronic dial 107. However, another change condition may be applied. For example, when at least one HDR content exists in a recording medium 250, the connection settings may be changed to the color gamut and gamma characteristic suitable for the HDR content without considering the rotation direction of the sub electronic dial 107. To realize this, the processes of steps S700 to S703 of FIG. 7A are changed. When the color gamuts and gamma characteristics of all content recorded on the recording medium 250 are sequentially confirmed and there exist the color gamut and gamma characteristic of the HDR content, the color gamut and gamma characteristic of the connection settings are changed.

(ii) Similar to modification (i) described above, the connection settings may be changed to match the SDR contents or HDR contents, the number of which is larger, among the content recorded on the recording medium 250. This can also be implemented by changing the processes of steps S700 to S703 of FIG. 7A and confirming the color gamuts and gamma characteristics of all the content recorded on the recording medium 250.

(iii) Each of the above-described embodiments has explained an example in which the user changes the reproduction content by rotating the sub electronic dial 107. However, the reproduction content may be changed by the cross key or another operation member. In this case, in accordance with the method of changing the content, the standby time from when the continuous change of the content is stopped until the connection settings are changed may be changed. To realize this, for example, the processes of steps S508 to S510 of FIG. 5B are changed, and the connection settings are immediately changed upon detection of release of the finger of the user from the button.

(iv) In association with modification (iii) described above, an operation such as a swipe on the touch panel may be applied as the method of changing the reproduction content. In this case, since the frequency of changing the content by a swipe is lower than the frequency of changing the content by the dial, the influence of flickering of a screen may be considered to be small, and the control of the connection settings of the present embodiment may not be executed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-131468, filed Aug. 10, 2023 which is hereby incorporated by reference herein in its entirety.

What is claimed is:

1. A display control apparatus comprising:
a selection unit that selects reproduction target content from a plurality of content;
an output unit that outputs, to a display unit, the reproduction target content selected by the selection unit; and
a control unit that controls setting information concerning a display characteristic set in the output unit and the display unit,
wherein the control unit controls
not to change the setting information based on the reproduction target content in a case where the selection unit continuously changes the reproduction target content, and
to change the setting information based on the reproduction target content in a case where the selection unit does not continuously change the reproduction target content.

2. The apparatus according to claim 1, further comprising:
a decode unit that decodes the content selected by the selection unit; and
a resize unit that resizes the decoded content in accordance with a resolution of the display unit.

3. The apparatus according to claim 1, wherein
the control unit sets a standby time in a case where the reproduction target content is not continuously changed, and changes the setting information in accordance with the content selected by the selection unit when the standby time elapses after the continuous change of the reproduction target content is stopped.

4. The apparatus according to claim 3, further comprising:
a determination unit that determines whether a display characteristic of candidate content that may be selected next after the content selected by the selection unit is the same as current setting information,
wherein the control unit sets the standby time in a case where there is a difference between the display characteristic of the candidate content and the current setting information to a time longer than the standby time in a case where the display characteristic of the candidate content is the same as the current setting information.

5. The apparatus according to claim 3, wherein
the control unit changes the standby time in accordance with a method of changing the reproduction target content.

6. The apparatus according to claim 1, wherein
the content is an image including one of a still image and a moving image, and
the display control apparatus is an image capture apparatus that generates the content.

7. The apparatus according to claim 6, wherein
the display unit is an external apparatus connected to the image capture apparatus, and
the display unit is in a blackout state while the setting information is changed.

8. The apparatus according to claim 1, wherein
the display characteristic includes an expressible color gamut and gamma characteristic of the content.

9. The apparatus according to claim 8, wherein
the content includes High Dynamic Range (HDR) content and Standard Dynamic Range (SDR) content, and
a color gamut and a gamma characteristic of the SDR content are BT601 and sRGB, and a color gamut and a gamma characteristic of the HDR content are BT2020 and PQ.

10. The apparatus according to claim 1, wherein
the output unit and the display unit are connected by an HDMI® cable, and
the setting information is an HDMI connection setting.

11. The apparatus according to claim 1, wherein
the control unit controls not to change the setting information based on the reproduction target content in a case where the selection unit continuously changes the reproduction target content, and to output, by the output unit, the reproduction target content converted in accordance with the setting information in a case where a display characteristic of the reproduction content does not match the setting information set in the output unit and the display unit.

12. The apparatus according to claim 1, wherein
in a case where the selection unit starts to continuously change the reproduction target content, the control unit obtains display characteristics of a plurality of candidate content that may be selected next after the content selected by the selection unit,
in a case where a ratio of content of a specific display characteristic among the display characteristics of the plurality of candidate content is not lower than a predetermined ratio, the control unit changes the setting information in accordance with the specific display characteristic, and
the control unit maintains the changed setting information until the continuous change of the reproduction target content ends.

13. The apparatus according to claim 12, wherein
in a case where the selection unit starts to continuously change the reproduction target content, the control unit changes the setting information to information suitable for Standard Dynamic Range (SDR) content or High Dynamic Range (HDR) content, the number of which is larger in the candidate content.

14. A method of controlling a display control apparatus which includes a selection unit that selects reproduction target content from a plurality of content, and an output unit that outputs, to a display unit, the reproduction target content selected by the selection unit,
the method comprising:
controlling setting information concerning a display characteristic set in the output unit and the display unit,
wherein the controlling is performed so as
not to change the setting information based on the reproduction target content in a case where the selection unit continuously changes the reproduction target content, and
to change the setting information based on the reproduction target content in a case where the selection unit does not continuously change the reproduction target content.

15. A non-transitory computer-readable storage medium storing a program for causing a computer to function as a display control apparatus comprising:
a selection unit that selects reproduction target content from a plurality of content;
an output unit that outputs, to a display unit, the reproduction target content selected by the selection unit; and
a control unit that controls setting information concerning a display characteristic set in the output unit and the display unit,
wherein the control unit controls
not to change the setting information based on the reproduction target content in a case where the selection unit continuously changes the reproduction target content, and
to change the setting information based on the reproduction target content in a case where the selection unit does not continuously change the reproduction target content.
